(19) United States
(12) Patent Application Publication
(10) Pub. No.: US 2007/0030052 A1
(43) Pub. Date: Feb. 8, 2007

(54) Boosted voltage generator with controlled pumping ratios

(76) Inventor: Kwang-Hyun Kim, Seoul (KR)

Correspondence Address: LAW OFFICE OF MONICA H CHOI, P O BOX 3424, DUBLIN, OH, 430160204, US

(21) Appl. No.: 11/481,725

(22) Filed: Jul. 6, 2006

(30) Foreign Application Priority Data
Aug. 4, 2005 (KR) 2005-71201

(51) Int. Cl. G05F 1/10

(52) U.S. Cl. 327/536

(57) ABSTRACT

A boosted voltage generator includes first and second pumping units and a pumping ratio controller. The first pumping unit is for pumping a first pumping ratio of charge at an output node in response to a first signal, and the second pumping unit is for pumping a second pumping ratio of charge at the output node in response to a second signal. The pumping ratio controller is for setting the first and second pumping ratios.

### BACKGROUND OF THE INVENTION

This application claims priority to Korean Patent Application No. 2005-71201, filed on Aug. 4, 2005 in the Korean Intellectual Property Office, the disclosure of which is incorporated herein in its entirety by reference.

1. Field of the Invention

The present invention relates generally to boosted voltage generators, and more particularly, to controlling the pumping ratios of multiple pumping units in a boosted voltage generator.

2. Description of the Related Art

Recent integrated circuits such as semiconductor memory devices are formed with high density and for low power consumption. Thus, a supply voltage VDD is lowered for such integrated circuits. Such Integrated circuits operating with a voltage higher than such VDD have a boosted voltage generator for generating such higher voltage.

In general, a boosted voltage (i.e., VPP) that is higher than VDD is desired for off-setting a threshold voltage drop Vth of a transistor. Such a boosted voltage generator is widely used in semiconductor memory devices, particularly as part of a word line driver, a bit line isolation circuit, and a data output buffer, for example. In such applications, VPP is desired to be at least VDD+Vth.

A semiconductor memory device may consume a large amount of charge from a word-line during access to a memory cell. For example, the amount of charge consumed for a word line enable is relatively large such that the amount of charge to be compensated is in turn relatively large. Such large amount of charge causes a strong electric field that may interfere with proper operation of devices within the semiconductor memory device.

Thus, a boosted voltage generator typically includes multiple charge pump circuits each pumping a portion of the total amount charge formed at an output node having VPP generated thereon. FIG. 1 shows a block diagram of an example conventional boosted voltage generator for driving word lines in a semiconductor memory device.

Referring to FIG. 1, a conventional boosted voltage generator includes a first pump circuit 10, a second pump circuit 20, and a detector 30. The first pump circuit 10 operates in response to an active signal ACT, and pumps a first pumping ratio of charge at the output node having VPP generated thereon. Here, the active signal ACT may be a row activation signal or a word line enable signal of a semiconductor memory device having the boosted voltage generator fabricated therein. The second pump circuit 20 operates in response to a detector signal DET from the detector 30, and pumps a second pumping ratio of charge at the output node.

More particularly, VPP is desired to be at a reference level. However, the charge pumped from the first pump circuit 10 may be consumed through dissipation paths such that VPP becomes lower than the reference level. In that case, the DET signal is activated by the detector, and the second pump circuit 20 operates to compensate by pumping more charge at the output node. Thus, the second pump circuit 20 operates when the detector signal DET and the ACT signal are both activated as indicated by an AND gate A12.

The detector 30 compares VPP with the reference level to activate the DET signal when VPP is lower than the reference level. For example, assume that an amount of total charge required at the output node when the word lines of the semiconductor memory device are enabled is normalized to 1. In that case, the first and second pump circuits 10 and 20 are desired to pump at least that amount of charge for preventing a voltage drop below VPP.

If more than such desired amount of charge is supplied from the first and second pump circuits 10 and 20, VPP is raised beyond the desired reference level. Thus, the conventional boosted voltage generator of FIG. 1 operates as follows. Initially when VPP is stable at the reference level, the detector 30 inactivates the DET signal, and the second pump circuit 20 does not operate. When an active signal ACT is activated, the first pump circuit 10 responds by pumping charge to raise VPP.

Then, when the word lines of the semiconductor memory device are enabled, a large amount of charge at the output node may be dissipated such that VPP is decreased below the reference level. In that case, the detector 30 activates the DET signal, and the second pump circuit 20 responds with a next active signal ACT and the activated DET signal to pump charge onto the output node. During such a next active signal, both the first and second pump circuits 10 and 20 operate to pump charge at the output node for generating VPP thereon.

Here, if both pump circuits 10 and 20 were to respond to the DET signal, VPP would have a greater voltage fluctuation (i.e. wider voltage separation between the low level and the high level). On the other hand, if both pump circuits 10 and 20 were to operate independently of the DET signal, VPP may be undesirably higher because of over-pumping by the pump circuits 10 and 20 in response to the ACT signal.

Therefore, the first and second pump circuits 10 and 20 are desired to have corresponding pumping ratios that result in a stable VPP at the output node. In the conventional boosted voltage generator, the pumping ratios of the pump circuits 10 and 20 are fixed from the time of design. However, the desired pumping ratios may vary depending on the production process, design errors, and other factors. Unfortunately, the conventional boosting voltage generator does not have a mechanism for changing the pumping ratio when such error occurs because the pumping ratios are fixed from the time of design in the prior art.

### SUMMARY OF THE INVENTION

Accordingly, a boosted voltage generator according to embodiments of the present invention includes a mechanism for variably setting the pumping ratios of multiple pumping units.

A boosted voltage generator according to an aspect of the present invention includes first and second pumping units and a pumping ratio controller. The first pumping unit is for pumping a first pumping ratio of charge at an output node in response to a first signal, and the second pumping unit is for pumping a second pumping ratio of charge at the output node in response to a second signal. The pumping ratio controller is for setting the first and second pumping ratios.

In one embodiment of the present invention, the first and second pumping ratios add up to 1, and the charge pumped by the first and second pumping units generates a boosted voltage at the output node.

In another embodiment of the present invention, the boosted voltage generator includes a detector that generates the second signal that is a detector signal by comparing the boosted voltage with a reference level. In that case, the first signal is an active signal.

In a further embodiment of the present invention, the boosted voltage generator includes a plurality of pump circuits, each pumping a respective pumping ratio of charge at the output node. In that case, the pumping ratio controller determines a first set of the pump circuits to comprise the first pumping unit and a second set of the pump circuits to comprise the second pumping unit. For example, the pump circuits have binary weighted pumping ratios of 1/(2ⁿ−1) to 2⁽ⁿ⁻¹⁾/(2ⁿ−1) when a number of the pump circuits is n that is a natural number.

In another embodiment of the present invention, the boosted voltage generator further includes a control signal generator for generating a plurality of control signals used by the pumping ratio controller for setting the first and second pumping ratios. For example, the control signal generator includes a plurality of fuse circuits each having a respective fuse that is cut or uncut for setting a logic state of a respective control signal.

The present invention may be used to particular advantage when the boosted voltage generator is formed within a memory device with the control signals being determined using MRS (mode register set) signals during testing of the memory device. However, the boosted voltage generator of the present invention may also be used in any other device or applications desiring a stable boosted voltage.

### BRIEF DESCRIPTION OF THE DRAWINGS

The above and other features and advantages of the present invention will become more apparent when described in detailed exemplary embodiments thereof with reference to the attached drawings in which:

FIG. 1 is the block diagram of a conventional boosted voltage generator;

FIG. 2 is the block diagram of a boosted voltage generator with controlled pumping ratios, according to an embodiment of the present invention;

FIG. 3 illustrates an example implementation of pumping units and a pumping ratio controller of FIG. 2, according to an embodiment of the present invention;

FIG. 4 shows an example circuit for generating a control signal of FIG. 3, according to an embodiment of the present invention;

FIG. 5 shows an example fuse circuit for generating a fuse output signal of FIG. 4, according to an embodiment of the present invention;

FIG. 6 shows an example plot of an enable signal complementary for the fuse circuit of FIG. 5, according to an embodiment of the present invention; and

FIG. 7 shows a specific example for forming first and second pumping units with respective pumping ratios, according to an example embodiment of the present invention.

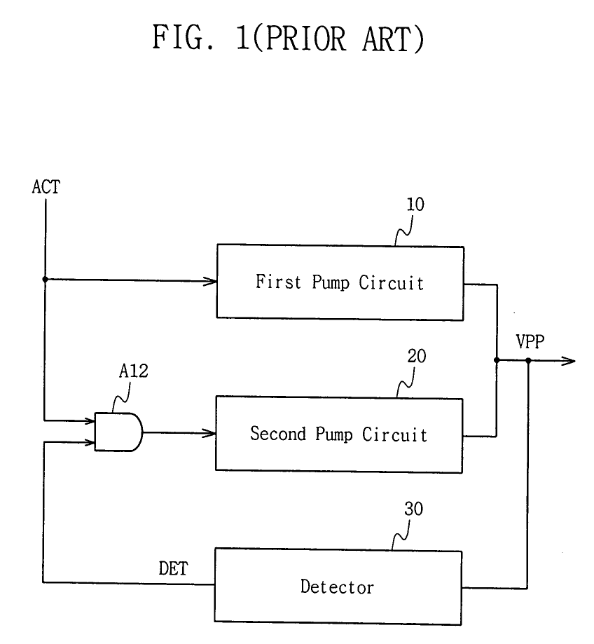

The figures referred to herein are drawn for clarity of illustration and are not necessarily drawn to scale. Elements having the same reference number in FIGS. 1, 2, 3, 4, 5, 6, and 7 refer to elements having similar structure and/or function.

### DETAILED DESCRIPTION OF THE INVENTION

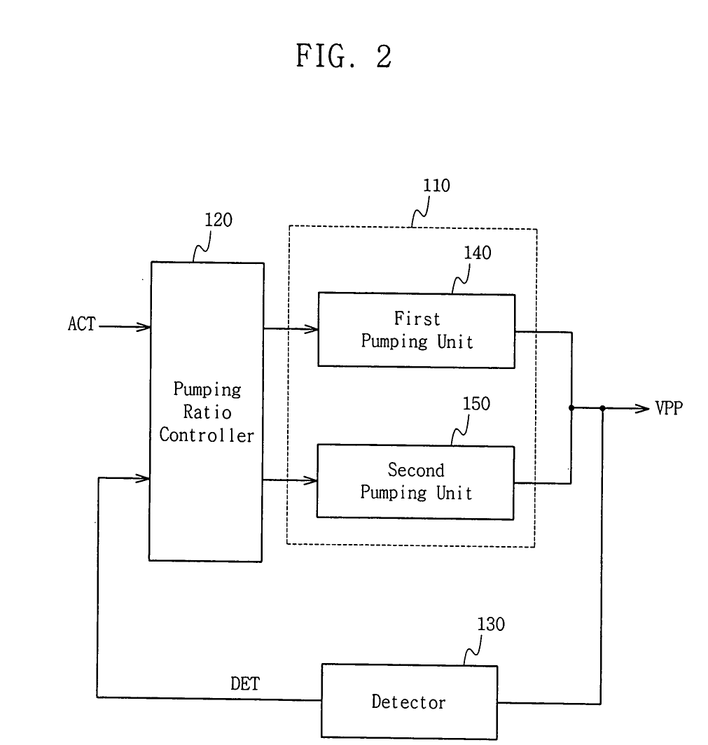

FIG. 2 shows a block diagram of a boosted voltage generator according to an embodiment of the present invention. Referring to FIG. 2, the boosted voltage generator includes a pumping unit 110, a pumping ratio controller 120, and a detector 130.

The pumping unit 110 is comprised of a first pumping unit 140 operating in response to an active signal ACT and a second pumping unit 150 operating in response to a detector signal DET. Embodiments of the present invention are described herein with the second pumping unit 150 operating in response to the DET signal alone. However, the present invention may also be practiced with the second pumping unit 150 operating in response to both the ACT signal and the DET signal.

In one aspect of the present invention, the boosted voltage generator of FIG. 2 is formed within a semiconductor memory device. During testing of such a semiconductor memory device, the pumping ratio controller 120 is used for determining an optimal respective pumping ratio for each of the first and second pumping units 140 and 150. Further, the pumping ratio controller 120 sets the respective pumping ratio of each of the first and second pumping units 140 and 150 during operation of the semiconductor memory device.

The first pumping unit 140 pumps a first pumping ratio of a total amount of charge at an output node having a boosted voltage VPP generated thereon. The second pumping unit 140 pumps a second pumping ratio of the total amount of charge at the output node. The pumping ratio controller 120 sets the first and second pumping ratios.

The total amount of charge pumped at the output node by the first and second pumping units 140 and 150 generates the boosted voltage VPP at the output node. The first and second pumping ratios of the first and second pumping units 140 and 150 add up to 1 in one embodiment of the present invention.

The detector 130 compares the boosted voltage VPP with a reference level to generate the DET signal. When VPP is lower than the reference level, the DET signal is activated such that the second pumping unit 150 operates to pump charge. In contrast, when VPP is equal to or higher than the reference level, the DET signal is inactivated, and the second pumping unit 150 does not operate.

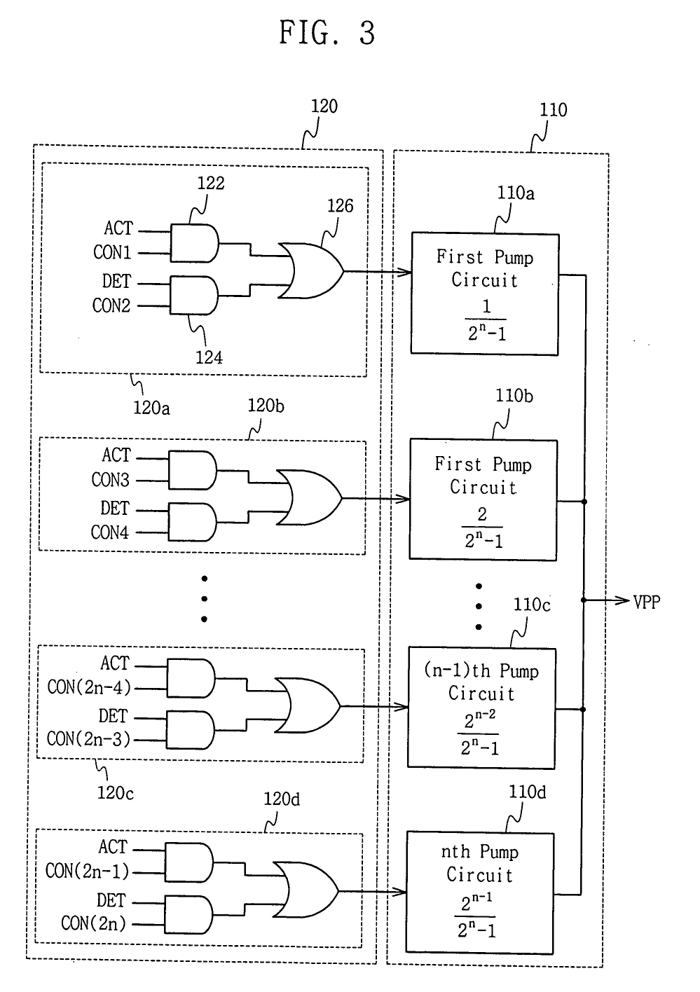

FIG. 3 illustrates an example implementation of the pumping unit 110 and the pumping ratio controller 120 of FIG. 2. Referring to FIG. 3, the pumping unit 110 includes a first pump circuit 110a, a second pump circuit 110b, and so on up to an nth pump circuit 110d with n being a natural number.

Each of such pump circuits has a respective pumping ratio. In one embodiment of the present invention, the respective pumping ratios of the pump circuits 110a, 110b, . . . , and 110d add up to 1. Each of the pump circuits 110a, 110b, . . . , and 110d pumps the respective pumping ratio of a total amount of charge formed at the output node having the boosted voltage VPP generated thereon.

In an example embodiment of the present invention, the respective pumping ratios of the pump circuits 110a, 110b, . . . , and 110d are binary weighted by having respective pumping ratios of 1/(2ⁿ−1) to 2⁽ⁿ⁻¹⁾/(2ⁿ−1), as illustrated in FIG. 3.

Operation of each of the pump circuits 110a, 110b, . . . , and 110d is controlled by a respective control circuit 120a, 120b, or so on up to 120d. The respective control circuits 120a, 120b, . . . , and 120d determine a first set of the pump circuits 110a, 110b, . . . , and 110d operating in response to the ACT signal and thus comprising the first pumping unit 140. Furthermore, the respective control circuits 120a, 120b, . . . , and 120d determine a second set of the pump circuits 110a, 110b, . . . , and 110d operating in response to the DET signal and thus comprising the second pumping unit 140.

Each of the pump circuits 110a, 110b, . . . , and 110d individually may be implemented according to mechanisms known to one of ordinary skill in the art for pumping charge onto a node.

The pumping ratio controller 120 determines the optimal respective pumping ratio for each of the first and second pumping units 140 and 150 during testing of the integrated circuit having the boosted voltage generator of FIG. 3 fabricated therein. Then, the pumping ratio controller 120 receives control signals, CON1, CON2, CON3, CON4, and so on up to CON(2n−1) and CON(2n) for setting the first set of the pump circuits 110a, 110b, . . . , and 110d to form the first pumping unit 140 and the second set of the pump circuits 110a, 110b, . . . , and 110d to form the second pumping unit 150, depending on the desired respective pumping ratio for each of the first and second pumping units 140 and 150.

Each of the control circuits 120a, 120b, . . . , and 120d is implemented similarly with a respective set of two control signals. For example, the first control circuit 120a includes a first AND-gate 122 having the ACT signal and the CON1 control signal as inputs. The first control circuit 120a also includes a second AND-gate 124 having the DET signal and the CON2 control signal as inputs. The outputs of the first and second AND-gates 122 and 124 are input by an OR-gate 126. The output of the OR-gate 126 is coupled to the first pump circuit 110a.

One of the control signals CON1 or CON2 is activated, and the other is deactivated, at any given time. Thus, one of the ACT signal or the DET signal is coupled to the first pump circuit 110a by the control circuit 120a. If the ACT signal is coupled to the first pump circuit 110a by the control circuit 120a, the first pump circuit 110a forms part of the first pumping unit 140. If the DET signal is coupled to the first pump circuit 110a by the control circuit 120a, the first pump circuit 110a forms part of the second pumping unit 150.

The other control circuits 120b . . . , and 120d are implemented similarly, and a respective pair of control signals for each control circuit determines which one of the ACT or DET signals is coupled to the respective pump circuit. If the ACT signal is coupled to the respective pump circuit, then that respective pump circuit forms part of the first pumping unit 140. If the DET signal is coupled to the respective pump circuit, then that respective pump circuit forms part of the second pumping unit 150.

The pumping ratio controller 120 uses mode register set (MRS) signals for determining the optimal respective pumping ratio for each of the pumping units 140 and 150. Upon determination of the optimal pumping ratios, fuse circuits are formed as part of a control signal generator for generating the control signals CON1, CON2, . . . , and so on up to CON(2n).

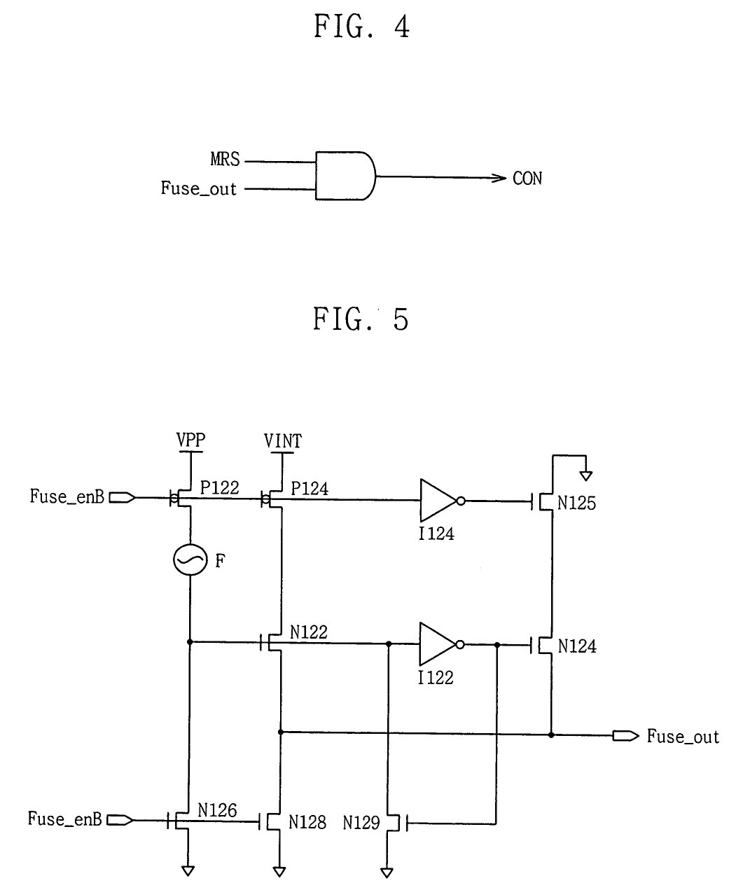

FIG. 4 shows an AND-gate that is used for generating a control signal CON which may be any of the control signals CON1, CON2, . . . , and so on up to CON(2n). Initially during testing of the integrated circuit having the boosted voltage generator of FIG. 3 fabricated therein, the Fuse_out signal in FIG. 4 is at a logical high state such that the CON signal is determined by a MRS signal. Such MRS signals are used for generating the control signals CON1, CON2, . . . , and so on up to CON(2n) for determining the optimal respective pumping ratio for each of the pumping units 140 and 150 that results in VPP stably being at the reference level.

Upon determination of the optimal logical states for the control signals CON1, CON2, . . . , and so on up to CON(2n), a respective fuse circuit as illustrated in FIG. 5 is used for generating a Fuse_out signal for setting the logical state of the control signal CON in FIG. 4. After initialization, the MRS signal in FIG. 4 is set to the logical high state such that the Fuse_out signal from the fuse circuit of FIG. 5 determines the logical state of the control signal CON in FIG. 4.

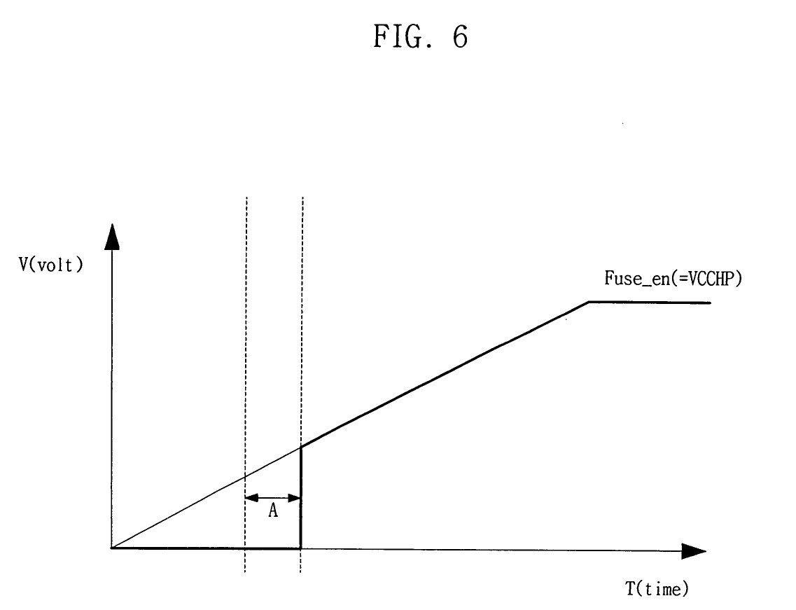

The fuse circuit of FIG. 5 includes PMOSFETs (p-channel metal oxide semiconductor field effect transistors) P122 and P124, NMOSFETs (N-channel metal oxide semiconductor field effect transistors) N122, N124, N125, N126, N128 and N129, inverters 1122 and 1124, and a fuse F, connected as illustrated in FIG. 6. During determination of the optimal logical states for the control signals CON1, CON2, . . . , and so on up to CON(2n) using the MRS signals in FIG. 4, the fuse F is not cut such that the Fuse_out signal is set to the logical high state.

After determination of the optimal logical states for the control signals CON1, CON2, . . . , and so on up to CON(2n), the fuse F is cut for setting the Fuse_out signal and thus the CON signal in FIG. 4 to the logical low state. Alternatively, the fuse F is uncut for setting the Fuse_out signal and thus the CON signal in FIG. 4 to the logical high state. The NMOSFET N129 and the inverter 1122 form a latch for maintaining such a logical state of the Fuse_out signal.

Referring to FIGS. 5 and 6, a fuse enable signal Fuse_en applied on each fuse circuit is similar to a power-up signal (i.e. an initiation signal VCCH) of the semiconductor memory device having the boosted voltage generator fabricated therein. However, the final level of Fuse_en is boosted such as by a level shifter to a higher voltage such as VPP, as illustrated in FIG. 6.

The Fuse_enB signal in FIG. 5 is complementary to the Fuse_en signal of FIG. 6. The Fuse_en signal of FIG. 6 may be used for a first fuse circuit generating one of the control signals such as CON1 applied to a control circuit 120a. In that case, a Fuse_enB signal that is complementary to the Fuse_en signal is used in a second fuse circuit for generating the other one of the control signals such as CON2 applied to the same control circuit 120a.

When the enable signal Fuse_enB has a logical high state during an initiation period A, and the Fuse_out signal has a logical low state but transitions to the logical high state after the initiation period A, if the fuse F is not cut. On the other hand, if the fuse F is cut, the Fuse_out signal is set to the logical low state during the initiation period A and is maintained at the logical low state thereafter.

The components of FIGS. 4 and 5 are used to generate one of the control signals CON1, CON2, . . . , and so on up to CON(2n). However, a respective set of such components of FIGS. 4 and 5 are similarly formed for generating each of the control signals CON1, CON2, . . . , and so on up to CON(2n) in the control signal generator.

A respective fuse F for each respective fuse circuit is cut or not cut for setting each of the control signals CON1, CON2, . . . , and so on up to CON(2n) to the desired logical state. Such a fuse F may be cut using laser cutting or other such similar fuse cutting technology.

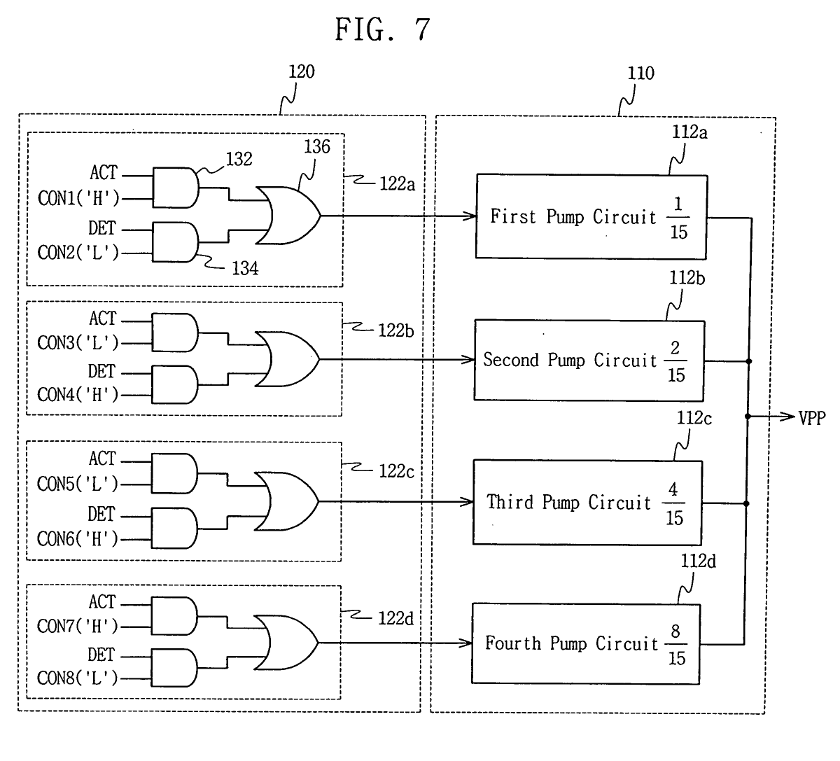

FIG. 7 illustrates example respective pumping ratios for the first and second pumping units 140 and 150 of FIG. 3. The example of FIG. 7 assumes four pump circuits 112a, 112b, 112c, and 112d each having respective binary-weighted pumping ratios of 1/15, 2/15, 4/15, and 8/15.

Assume that testing of the integrated circuit having the boosted voltage generator of FIG. 7 fabricated therein determines the optimal respective pumping ratios for the first and second pumping units 140 and 150 to be 9/15 and 6/15, respectively (i.e., 9:6).

In that case, the first and fourth pump circuits 112a and 112d are desired to form the first pumping unit 140 having the desired pumping ratio of 9/15 which is equal to the sum of the pumping ratios 1/15 and 8/15 of the first and fourth pump circuits 112a and 112d. Similarly, the second and third pump circuits 112b and 112c are desired to form the second pumping unit 150 having the desired pumping ratio of 6/15 which is equal to the sum of the pumping ratios 2/15 and 4/15 of the second and third pump circuits 112b and 112c.

Thus, the first and fourth control circuits 122a and 122d are desired to couple the ACT signal to the first and fourth pump circuits 112a and 112d. Similarly, the second and third control circuits 122b and 122c are desired to couple the DET signal to the second and third pump circuits 112b and 112c.

To that end, the respective pair of control signals to each of the control circuits 122a, 122b, 122c, and 122d is set appropriately by a respective fuse circuit for each of such control signals. The control signals CON1 and CON2 to the first control circuit 122a are set to the logical high state (‘H’) and the logical low state (‘L’), respectively, such that the first control circuit 122a couples the ACT signal to the first pump circuit 12a. Similarly, the control signals CON7 and CON8 to the fourth control circuit 122d are set to the logical high state (‘H’) and the logical low state (‘L’), respectively, such that the fourth control circuit 122d couples the ACT signal to the fourth pump circuit 112d.

Also, the control signals CON3 and CON4 to the second control circuit 122bare set to the logical low state (‘L’) and the logical high state (‘H’), respectively, such that the second control circuit 122b couples the DET signal to the second pump circuit 112b. Similarly, the control signals CON5 and CON6 to the third control circuit 122c are also set to the logical low state (‘L’) and the logical high state (‘H’), respectively, such that the third control circuit 122c couples the DET signal to the third pump circuit 112c.

In this manner, the respective pumping ratios of the first and second pumping units 140 and 150 may be adjusted by cutting or not cutting the fuses corresponding to control signals to the pump ratio controller 120. Thus, the respective pumping ratios of the first and second pumping units 140 and 150 are not fixed from the design stage. Such adjustment of the respective pumping ratios is desired for accounting for process variations, design errors, and other factors that may lead to changes in the optimal pumping ratios.

The foregoing is by way of example only and is not intended to be limiting. For example, any numbers or number of elements as described and illustrated herein is by way of example only. In addition, the boosted voltage generator of embodiments of the present invention has been described as being formed within a semiconductor memory device. However, the boosted voltage generator of the present invention may also be used in any other devices or applications desiring a stable boosted voltage.

The present invention is limited only as defined in the following claims and equivalents thereof.

What is claimed is:

1. A boosted voltage generator comprising:
a first pumping unit for pumping a first pumping ratio of charge at an output node in response to a first signal;
a second pumping unit for pumping a second pumping ratio of charge at the output node in response to a second signal; and
a pumping ratio controller for setting the first and second pumping ratios.

2. The boosted voltage generator of claim 1, wherein the first and second pumping ratios add up to 1, and wherein the charge pumped by the first and second pumping units generates a boosted voltage at the output node.

3. The boosted voltage generator of claim 2, further comprising:
a detector for generating the second signal that is a detector signal by comparing the boosted voltage with a reference level, and wherein the first signal is an active signal.

4. The boosted voltage generator of claim 1, further comprising:
a plurality of pump circuits, each pumping a respective pumping ratio of charge at the output node, wherein the pumping ratio controller determines a first set of the pump circuits to comprise the first pumping unit and a second set of the pump circuits to comprise the second pumping unit.

5. The boosted voltage generator of claim 4, wherein the pump circuits have binary weighted pumping ratios of 1/(2ⁿ−1) to 2⁽ⁿ⁻¹⁾/(2ⁿ−1) when a number of the pump circuits is n that is a natural number.

6. The boosted voltage generator of claim 1, further comprising:
a control signal generator for generating a plurality of control signals used by the pumping ratio controller for setting the first and second pumping ratios.

7. The boosted voltage generator of claim 6, wherein the control signal generator includes a plurality of fuse circuits each having a respective fuse that is cut or uncut for setting a logic state of a respective control signal.

8. The boosted voltage generator of claim 6, wherein the boosted voltage generator is formed within a memory device, and wherein the control signals are determined using MRS (mode register set) signals during testing of the memory device.

9. A boosted voltage generator comprising:
a plurality of pump circuits, each pumping a respective pumping ratio of charge at an output node; and
a pumping ratio controller for determining a first set of the pump circuits to comprise a first pumping unit and a second set of the pump circuits to comprise a second pumping unit.

10. The boosted voltage generator of claim 9, wherein the first pumping unit pumps a first pumping ratio of charge at the output node in response to a first signal, and wherein the second pumping unit pumps a second pumping ratio of charge at the output node in response to a second signal.

11. The boosted voltage generator of claim 10, wherein the first and second pumping ratios add up to 1, and wherein the charge pumped by the first and second pumping units generates a boosted voltage at the output node.

12. The boosted voltage generator of claim 11, further comprising:
a detector for generating the second signal that is a detector signal by comparing the boosted voltage with a reference level, and wherein the first signal is an active signal.

13. The boosted voltage generator of claim 9, wherein the pump circuits have binary weighted pumping ratios of 1/(2ⁿ−1) to 2⁽ⁿ⁻¹⁾/(2ⁿ−1) when a number of the pump circuits is n that is a natural number.

14. The boosted voltage generator of claim 9, further comprising:
a control signal generator for generating a plurality of control signals used by the pumping ratio controller for determining the first set for the first pumping unit and the second set for the second pumping unit.

15. The boosted voltage generator of claim 14, wherein the control signal generator includes a plurality of fuse circuits each having a respective fuse that is cut or uncut for setting a logic state of a respective control signal.

16. The boosted voltage generator of claim 15, wherein the boosted voltage generator is formed within a memory device, and wherein the control signals are determined using MRS (mode register set) signals during testing of the memory device.

17. A method of generating a boosted voltage comprising:
pumping a first pumping ratio of charge at an output node in response to a first signal;
pumping a second pumping ratio of charge at the output node in response to a second signal; and
generating control signals that determine each of the first and second pumping ratios.

18. The method of claim 17, wherein the first and second pumping ratios add up to 1, and wherein the charge pumped by the first and second pumping units generates a boosted voltage at the output node.

19. The method of claim 18, further comprising:
generating the second signal that is a detector signal by comparing the boosted voltage with a reference level, and wherein the first signal is an active signal.

20. The method of claim 17, wherein the control signals determine a first set of a plurality of pump circuits to comprise the first pumping unit and a second set of the pump circuits to comprise the second pumping unit, each pump circuit pumping a respective pumping ratio of charge at the output node.

21. The method of claim 20, wherein the pump circuits have binary weighted pumping ratios of 1/(2ⁿ−1) to 2⁽ⁿ⁻¹⁾/(2ⁿ−1) when a number of the pump circuits is n that is a natural number.

22. The method of claim 17, further comprising:
determining a logic state for each control signal using MRS (mode register set) signals during testing of the memory device.
